(19) United States
(12) Patent Application Publication
(10) Pub. No.: US 2024/0316839 A1
(43) Pub. Date: Sep. 26, 2024

(54) TOOLS AND METHODS FOR FABRICATION OF THERMOPLASTIC PANELS

(71) Applicant: The Boeing Company, Arlington, VA (US)

(72) Inventors: Feride Nur Sasal, Istanbul (TR); Ozlem Turkarslan, Istanbul (TR)

(73) Assignee: The Boeing Company, Arlington, VA (US)

(21) Appl. No.: 18/189,423

(22) Filed: Mar. 24, 2023

(51) Int. Cl. B29C 43/56; B29C 43/12; B29C 43/18; B29C 43/36; B29C 43/52; B29C 43/58

(52) U.S. Cl. CPC B29C 43/56; B29C 43/12; B29C 43/18; B29C 43/3642; B29C 43/52; B29C 43/58; B29C 2043/108; B29C 2043/3647; B29C 2043/566; B29C 2043/567; B29C 2043/5816; B29L 2007/002

(57) ABSTRACT

A tool for fabrication of a thermoplastic panel includes a sealed vessel, a membrane and a heater. The sealed vessel defines a volume. The sealed vessel includes first and second fluid ports. The membrane is disposed within the volume to define first and second chambers. The first chamber receives a skin and a core of the thermoplastic panel. The first chamber selectively applies a first fluidic pressure to the skin and the core in response to receiving a first fluid via the first fluid port. The membrane abuts a major surface of the thermoplastic panel. The second chamber selectively applies a second fluidic pressure to the membrane in response to receiving a second fluid via the second fluid port. The heater selectively directs heat toward the first chamber. A method for fabrication of the thermoplastic panel is provided. Various examples of thermoplastic panels are also provided.

### FIELD

The present disclosure relates generally to thermoplastic panels and, particularly, to various tools and methods for fabrication of thermoplastic panels. Examples of a thermoplastic panel include a thermoplastic sandwich panel and a thermoplastic single skin panel. The tools and methods for fabrication of a thermoplastic panel apply pressures and heat to fusion bond the skin of the panel to the core in a non-isothermal manner. Applications to various thermoplastic materials are contemplated. Likewise, fabrication using various pressures, temperatures, and control mechanisms are also contemplated.

### BACKGROUND

Fabrication of thermoplastic sandwich structure results in delamination of the thermoplastic composite skin when low external pressure is applied to the sandwich during attempts at fusion bonding. Conversely, the application of higher pressures results in core crush or deformation because the process temperature is above the melting temperature (for semi-crystalline polymer) or the glass transition temperature (for amorphous polymer) of the thermoplastic core material. Additionally, the process window for fusion bonding of a skin to the core is limited on the one hand by a weak bond strength at low temperatures and on the other hand by core collapse and skin delamination at higher temperatures. Under these circumstances, isothermal manufacturing methods (e.g., use of an oven or an autoclave) cannot be used to join the skins and core of the thermoplastic sandwich. Moreover, current use of non-isothermal methods in fusion bonding results in uncontrolled bond line homogeneity.

Accordingly, those skilled in the art continue with research and development efforts to improve the design of tools for fabrication of thermoplastic panels to streamline manufacturing and to implement more consolidated manufacturing processes.

### SUMMARY

Disclosed are examples of tools and methods for fabrication of a thermoplastic panel. Examples of thermoplastic panels are also disclosed. The following is a non-exhaustive list of examples, which may or may not be claimed, of the subject matter according to the present disclosure.

In an example, the disclosed tool for fabrication of a thermoplastic panel includes a sealed vessel, a membrane and a heater. The sealed vessel defines a volume. The sealed vessel includes a first fluid port and a second fluid port. The membrane is disposed within the volume to define a first chamber and a second chamber. The first chamber is configured to receive a first skin and a core of the thermoplastic panel. The first chamber is also configured to selectively apply a first fluidic pressure to the first skin and the core in response to receiving a first fluid via the first fluid port. The membrane is configured to abut a major surface of the thermoplastic panel. The second chamber is configured to selectively apply a second fluidic pressure to the membrane in response to receiving a second fluid via the second fluid port. The heater is configured to selectively direct heat toward the first chamber.

In an example, the disclosed method for fabrication of a thermoplastic panel includes: (1) selectively applying a second fluid pressure to a membrane supporting the thermoplastic panel, wherein the thermoplastic panel includes a first skin and a core previously positioned within a sealed vessel divided into a first chamber and a second chamber by the membrane, the second fluid pressure being within the second chamber; (2) selectively applying a first fluid pressure to the first skin and the core in the first chamber; and (3) selectively directing heat toward the first chamber to heat a bond line between the first skin and the core to a predetermined temperature associated with creating a fusion bond at the bond line.

In an example, the disclosed thermoplastic panel a first skin and a core. The core bonded to the first skin. The core includes a honeycomb structure with an array of hollow cells that are orthogonal to the first skin. The array of hollow cells formed by cell walls. The walls have a plurality of breather holes such that the honeycomb structure is air permeable from cell to cell.

Other examples of the disclosed tools and methods for fabrication of a thermoplastic panel as well as the disclosed thermoplastic panels will become apparent from the following detailed description, the accompanying drawings and the appended claims.

### BRIEF DESCRIPTION OF THE DRAWINGS

FIG. 1 is a functional diagram of an example of a tool for fabrication of a thermoplastic panel;

FIG. 2 is an exploded view of an example of a thermoplastic panel;

FIGS. 3A and 3B provide top and side views of an example of an air permeable thermoplastic honeycomb structure for a thermoplastic panel;

FIG. 4 is a top view of an example of a heater for the tool of FIG. 1;

FIG. 5 is a top view of an example of a heat exchanger for the tool of FIG. 1;

FIG. 6 is a top view of another example of a heat exchanger for the tool of FIG. 1;

FIG. 7 provides a top view of the tool of FIG. 1;

FIG. 8 is a cross-section functional diagram of the tool of FIG. 1;

FIGS. 9A and 9B provide a flow diagram of an example of a method for fabrication of a thermoplastic panel;

FIG. 10, in combination with FIGS. 9A and 9B, is a flow diagram of another example of a method for fabrication of a thermoplastic panel;

FIG. 11, in combination with FIGS. 9A, 9B and 10, is a flow diagram of yet another example of a method for fabrication of a thermoplastic panel;

FIG. 12, in combination with FIGS. 9A and 9B, is a flow diagram of still another example of a method for fabrication of a thermoplastic panel;

FIG. 13, in combination with FIG. 9A, is a flow diagram of still yet another example of a method for fabrication of a thermoplastic panel;

FIG. 14A through 14F, provide a graph and images of an example of a heating and cooling cycle during a trial fabrication of an example of a thermoplastic panel using an example of the tool disclosed herein;

FIG. 15 is a block diagram of aircraft production and service methodology; and

FIG. 16 is a schematic illustration of an aircraft.

### DETAILED DESCRIPTION

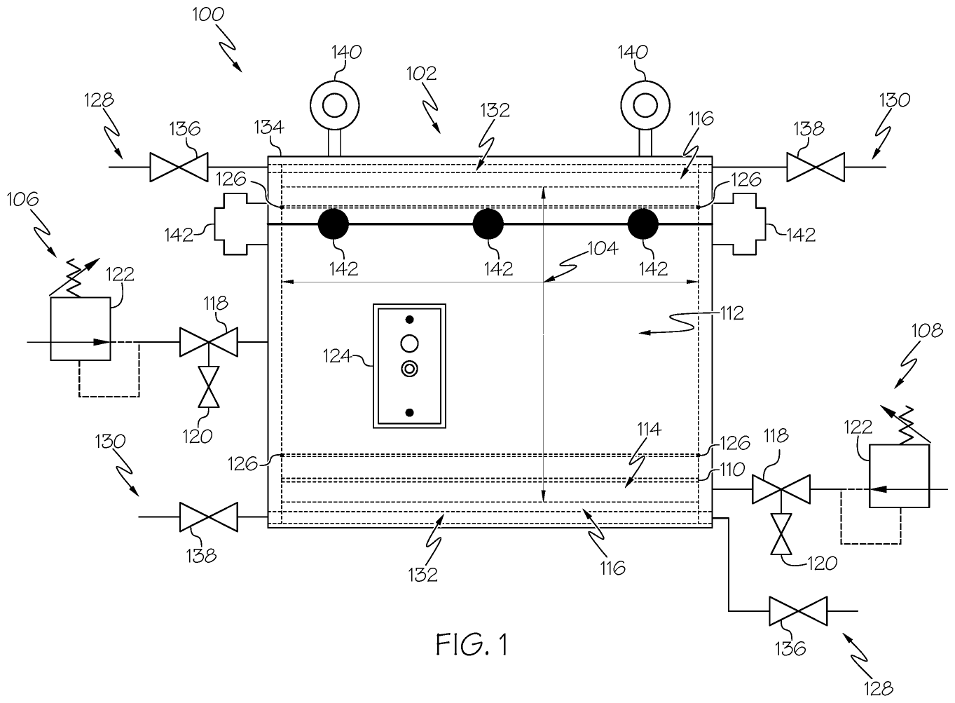

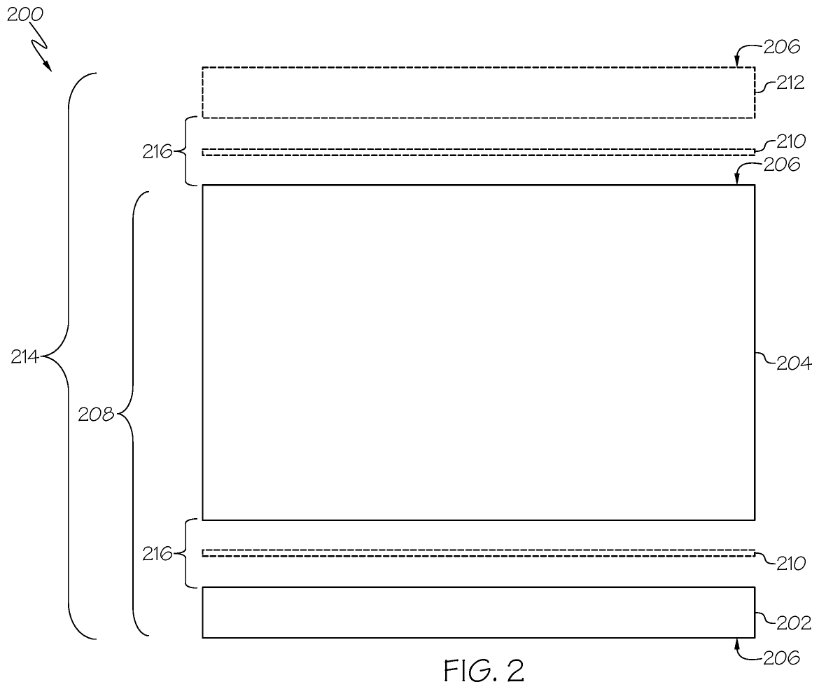

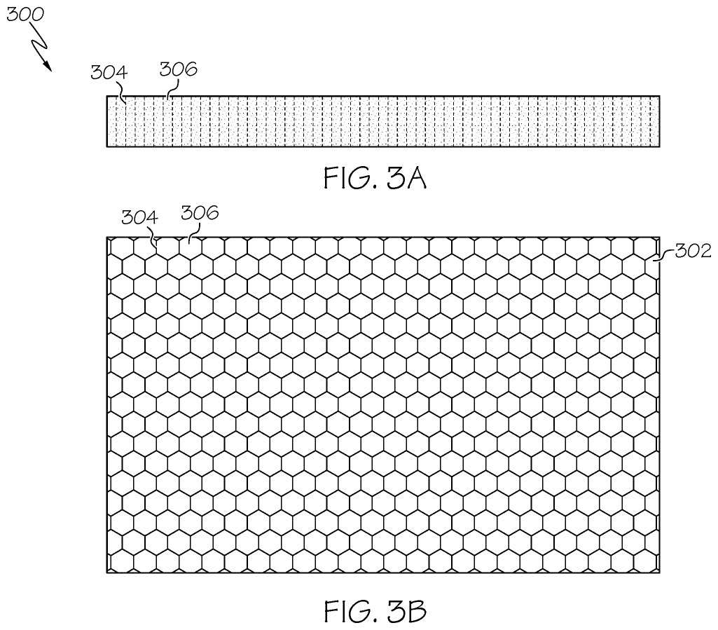

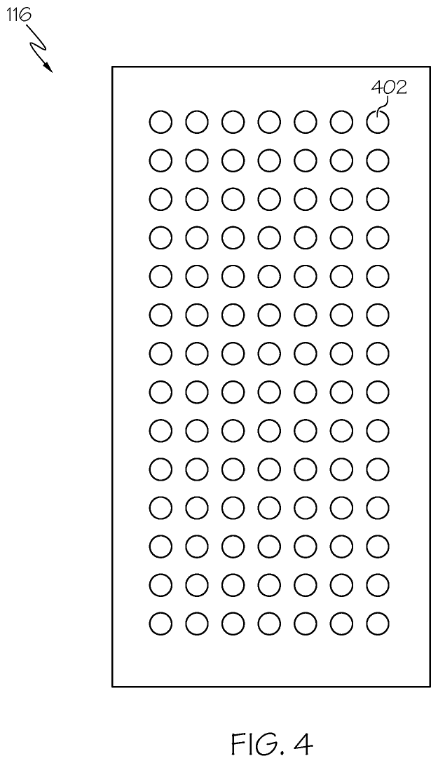

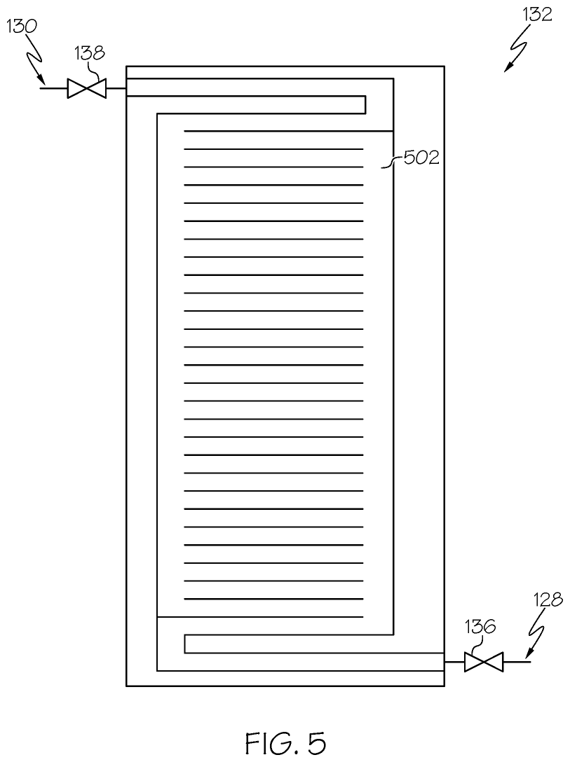

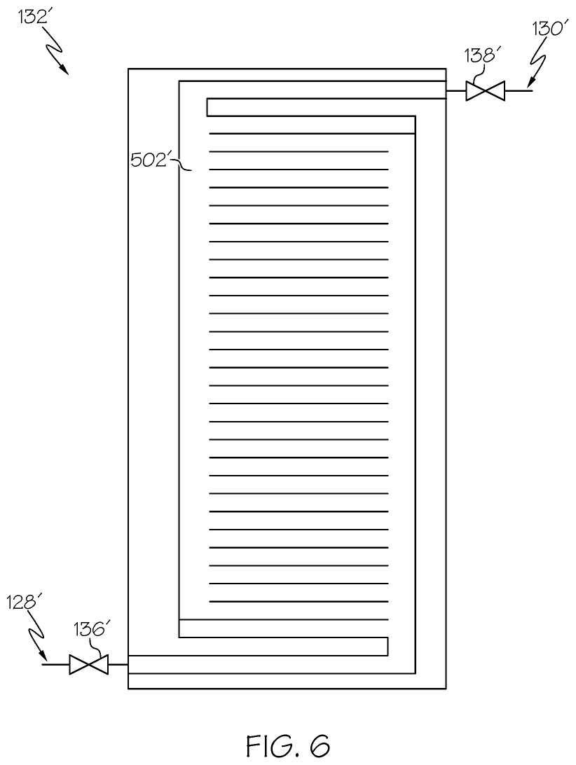

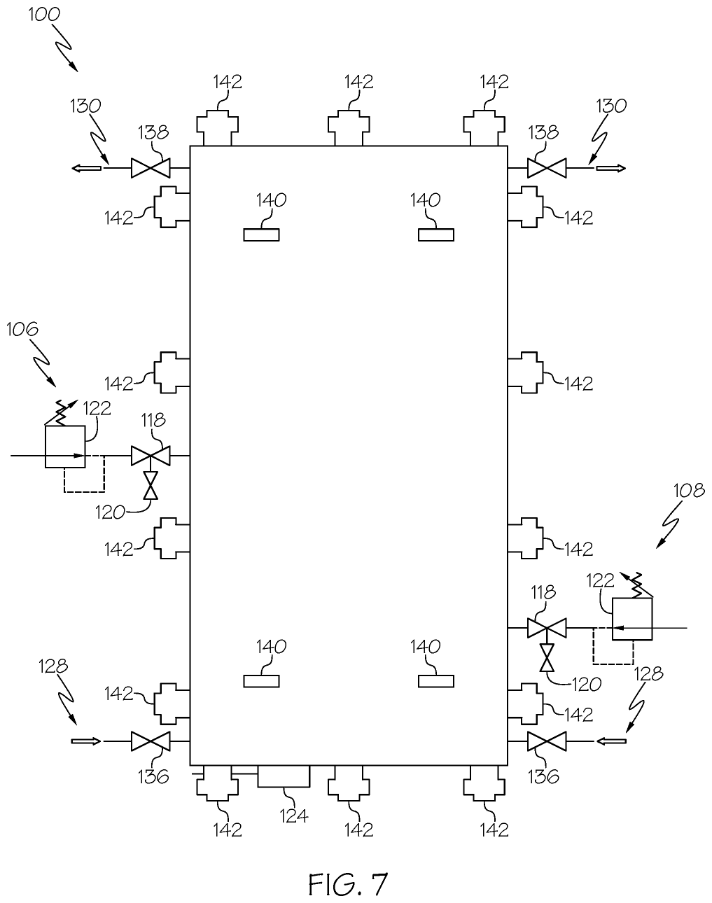

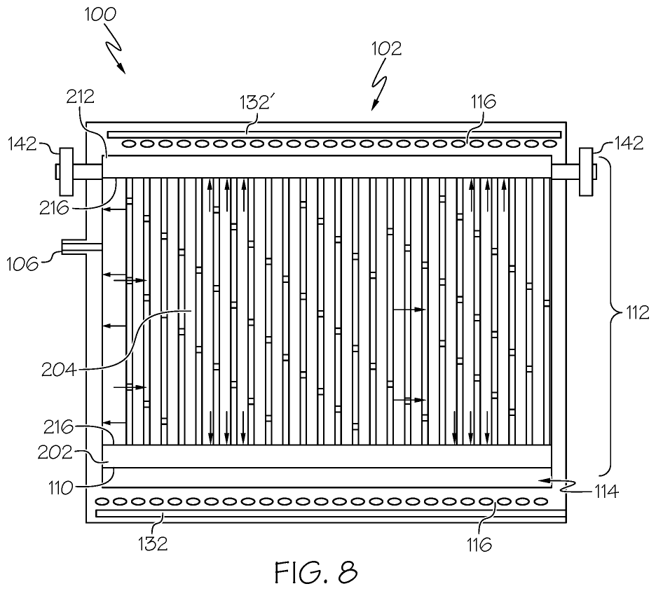

Referring generally to FIGS. 1, 2, 3A, 3B and 4-8, by way of examples, the present disclosure is directed to a tool 100 for fabrication of a thermoplastic panel 200. FIGS. 1, 7 and 8 disclose an example of the tool 100 that includes, for example, a sealed vessel 102, a membrane 110 and a heater 116. FIGS. 1, 7 and 8 also disclose a heat exchanger 132 and other components of the tool 100. FIG. 2 discloses an example of the thermoplastic panel 200. FIGS. 3A and 3B disclose an example of an air permeable thermoplastic honeycomb structure 300 for the thermoplastic panel 200. FIG. 4 discloses an example of the heater 116. FIGS. 5 and 6 disclose several examples of the heat exchanger 132.

With reference again to FIGS. 1, 2, 3A, 3B and 4-8, in one or more examples, a tool 100 for fabrication of a thermoplastic panel 200 includes a sealed vessel 102, a membrane 110 and a heater 116. The sealed vessel 102 defines a volume 104. The sealed vessel 102 includes a first fluid port 106 and a second fluid port 108. The membrane 110 is disposed within the volume 104 to define a first chamber 112 and a second chamber 114. The first chamber 112 is configured to receive a first skin 202 and a core 204 of the thermoplastic panel 200. The first chamber 112 is also configured to selectively apply a first fluidic pressure to the first skin 202 and the core 204 in response to receiving a first fluid via the first fluid port 106. The membrane 110 is configured to abut a major surface 206 of the thermoplastic panel 200. The second chamber 114 is configured to selectively apply a second fluidic pressure to the membrane 110 in response to receiving a second fluid via the second fluid port 108. The heater 116 is configured to selectively direct heat toward the first chamber 112.

In another example of the tool 100, the first fluid port 106 includes at least one of a shut off valve 118, a bleed valve 120 and a pressure regulator valve 122. In a further example, the shut off valve 118 is configured to block the first fluid from receipt by the first chamber 112. In another further example, the bleed valve 120 is configured to bleed pressure from the first chamber 112 down to an ambient pressure after the first fluid is no longer applied to the first chamber 112. In yet another further example, the pressure regulator valve 122 is configured to adjust a supply pressure of the first fluid to a predetermined tool pressure for fabrication of the thermoplastic panel 200. In an even further example, the predetermined tool pressure for the first fluid ranges between about 2.5 bar (e.g., about 36 psi) and about 6.9 bar (e.g., about 100 psi) or any suitable tool pressure range. In other examples, the predetermined tool pressure for the first fluid may be about the same as the pressure of the second fluid.

In yet another example of the tool 100, the second fluid port 108 includes at least one of a shut off valve 118, a bleed valve 120 and a pressure regulator valve 122.

In a further example, the shut off valve 118 is configured to block the second fluid from receipt by the second chamber 114.

In another further example, the bleed valve 120 is configured to bleed pressure from the second chamber 114 down to an ambient pressure after the second fluid is no longer applied to the second chamber 114.

In yet another further example, the pressure regulator valve 122 is configured to adjust a supply pressure of the second fluid to a predetermined tool pressure for fabrication of the thermoplastic panel 200. In an even further example, the predetermined tool pressure for the second fluid ranges between about 2.5 bar (e.g., about 36 psi) and about 6.9 bar (e.g., about 100 psi) or any suitable tool pressure range. In other examples, the predetermined tool pressure for the second fluid may be about the same as the pressure of the first fluid.

In still another example of the tool 100, the membrane 110 includes a metal alloy. In a further embodiment, the metal alloy includes steel. The membrane 110 thickness may be about 1/10^{th} of the thickness of the first skin 202. For example, if the thickness of the first skin 202 is about 2 mm, the thickness of the membrane may be about 0.2 mm. The thickness of the membrane 110 may vary between a thicker middle section and a thinner weld section around the perimeter.

In still yet another example of the tool 100, the first skin 202 includes a high-performance thermoplastic polymer. In a further example, the high-performance thermoplastic polymer includes a polyetherketoneketone (PEKK) polymer, a polyetheretherketone (PEEK) polymer, a low melt (LM) polyaryletherketone (PAEK) polymer or any suitable high-performance thermoplastic polymer in any suitable combination. In other examples, the first skin 202 may include multiple plies.

In another example of the tool 100, the core 204 includes a high-performance thermoplastic polymer. In a further example, the high-performance thermoplastic polymer includes a LM PAEK polymer, a PEKK polymer, a PEEK polymer, a polyetherimide (PEI) polymer, a polyphenylsulfone (PPSU), a polyamide-imide (PAI) polymer or any suitable high-performance thermoplastic polymer in any suitable combination.

In yet another example of the tool 100, the core 204 includes an air permeable thermoplastic foam, an air permeable thermoplastic honeycomb structure 300 or any suitable core material in any suitable combination. In a further example, the air permeable thermoplastic honeycomb structure 300 includes an array of hollow cells 302 orthogonal to the first skin 202. The array of hollow cells 302 formed by cell walls 304. The cell walls 304 having a plurality of breather holes 306 such that the air permeable thermoplastic honeycomb structure 300 is air permeable from cell to cell. In an even further example, the array of hollow cells 302 includes octagonal-shaped cells, hexagonal-shaped cells, rectangular-shaped cells, square-shaped cells, tubular-shaped cells, corrugated-shaped cells, triangular-shaped cells or cells of any suitable shape in any suitable combination.

In still another example of the tool 100, the thermoplastic panel 200 is a thermoplastic single skin panel 208.

In still yet another example of the tool 100, the first chamber 112 is configured to receive an interlayer film 210 between the first skin 202 and the core 204. In this example, the thermoplastic panel 200 also includes the interlayer film 210. In a further example, the interlayer film 210 includes a high-performance thermoplastic polymer. In an even further example, the high-performance thermoplastic polymer includes a LM PAEK polymer, a PEKK polymer, a PEEK polymer, a PEI polymer, a PAI polymer, a PPSU polymer or any suitable high-performance thermoplastic polymer in any suitable combination.

In another example of the tool 100, the first chamber 112 is configured to receive a second skin 212 such that the core 204 is disposed between the first skin 202 and the second skin 212. In this example, the thermoplastic panel 200 also includes the second skin 212. In a further example, the thermoplastic panel 200 is a thermoplastic sandwich panel 214. In another further example, the second skin 212 includes a high-performance thermoplastic polymer. In an even further example, the high-performance thermoplastic polymer includes a PEKK polymer, a PEEK polymer, a LM PAEK polymer or any suitable high-performance thermoplastic polymer in any suitable combination. In other examples, the second skin 212 may include multiple plies.

In another example of the tool 100, the first fluid includes a dry air, an inert gas, a nitrogen gas, or any suitable fluid in any suitable combination. The first fluid is selected to facilitate heat transfer by convection in the first chamber 112 and to limit heat transfer by conduction.

In yet another example of the tool 100, the first fluid port 106 is configured to interface with a supply line from a first fluid source. In a further example, the first fluid is received by the first chamber 112 in response to at least one of activating the first fluid source, opening the supply line, regulating a supply pressure for the first fluid to a tool pressure and opening the first fluid port 106.

In still another example of the tool 100, the second fluid includes a dry air, an inert gas, a nitrogen gas, a mineral-based oil, a synthetic-based oil or any suitable fluid in any suitable combination. The second fluid may be selected to facilitate heat transfer by conduction through the second chamber 114 toward the first chamber 112.

In still yet another example of the tool 100, the second fluid port 108 is configured to interface with a supply line from a second fluid source. In a further example, the second fluid is received in the second chamber 114 in response to at least one of activating the second fluid source, opening the supply line, regulating a supply pressure for the second fluid to a tool pressure and opening the second fluid port 108.

In another example of the tool 100, the heater 116 is disposed below the second chamber 114.

With reference again to FIGS. 1, 2, 4, 5, 7 and 8, in one or more examples of the tool 100, the heater 116 includes a plurality of electric cartridge heaters 402 distributed across the sealed vessel 102 in relation to a major face of the first skin 202. In another example of the tool 100, the plurality of electric cartridge heaters 402 includes a swage cartridge heater, a standard cartridge heater, or any suitable electric cartridge heater in any suitable combination.

In yet another example, the tool 100 also includes a heating controller 124 in operative communication with the heater 116 to selectively apply electrical power to the plurality of electric cartridge heaters 402 after the second fluid is received by the second chamber 114 and after the first fluid is received by the first chamber 112. The heating controller 124 is configured to remove electrical power from the plurality of electric cartridge heaters 402 after the first skin 202 and the core 204 of the thermoplastic panel 200 are fusion bonded at a bond line 216 between the first skin 202 and the core 204.

In a further example, the heating controller 124 is configured to remove electrical power from the plurality of electric cartridge heaters 402 based at least in part on a predetermined heating time. In an even further example, the predetermined heating time ranges between about 35 seconds and about 95 seconds, about 50 seconds and about 80 seconds, about 60 seconds and about 70 seconds or any suitable heating time range.

In another further example of the tool 100, the sealed vessel 102 also includes at least one temperature sensor 126 within the first chamber 112 and proximate to the bond line 216 between the first skin 202 and the core 204. The heating controller 124 is in operative communication with at least one temperature sensor 126 and configured to remove electrical power from the plurality of electric cartridge heaters 402 based at least in part on a temperature signal from the at least one temperature sensor 126 indicating a predetermined temperature associated with creating a fusion bond is detected proximate to the bond line 216. In an even further example, the predetermined temperature ranges between about 240° C. and about 280° C., about 250° C. and about 270° C., about 255° C. and about 265° C., about 310° C. and about 350° C. about 335° C. and about 375° C. or any suitable temperature range.

Generally, the heating controller 124 uses the at least one temperature sensor 126 to control the heater 116 for a non-isothermal heating and cooling cycle to create the fusion bond between the first skin 202 and the core 204 of the thermoplastic panel 200.

With reference again to FIGS. 1, 2, 5, 7 and 8, in one or more examples of the tool 100, the heater 116 is configured to selectively heat a bond line 216 between the first skin 202 and the core 204 of the thermoplastic panel 200 to a predetermined temperature associated with creating a fusion bond at the bond line 216. In yet another example of the tool 100, the predetermined temperature ranges between about 240° C. and about 280° C., about 250° C. and about 270° C., about 255° C. and about 265° C., about 310° C. and about 350° C., about 335° C. and about 375° C. or any suitable temperature range.

In still another example of the tool 100, the sealed vessel 102 also includes an inlet fluid port 128 and an outlet fluid port 130. In this example, the tool 100 also includes a heat exchanger 132. The heat exchanger 132 includes a plurality of cooling channels 502 in fluid communication with the inlet fluid port 128 and the outlet fluid port 130. The heat exchanger 132 is disposed proximate to the heater 116 on an opposing side of the heater 116 in relation to the first chamber 112. The heat exchanger 132 is configured to transfer heat from the bond line 216 of the thermoplastic panel 200 to a working fluid flowing through the plurality of cooling channels 502 in response to receiving the working fluid via the inlet fluid port 128.

In a further example, the heat exchanger 132 is configured to route the working fluid through the plurality of cooling channels 502 and out the outlet fluid port 130, 130′.

In another further example, the inlet fluid port 128 is configured to interface with a supply line from a working fluid source and the outlet fluid port 130 is configured to interface with a return line to the working fluid source. In an even further example, the working fluid is received by the heat exchanger 132 in response to at least one of activating the working fluid source, opening the supply line, adjusting a flow rate for the working fluid, opening an inlet valve 136 at the inlet fluid port 128 and opening an outlet valve 138 at the outlet fluid port 130. The flow rate and temperature of the working fluid received by the heat exchanger 132 may be adjusted to achieve desired temperatures at the bond line 216 at certain time intervals during a fusion bonding cycle.

In yet another further example, the working fluid includes a mineral-based oil, a synthetic-based oil, a coolant liquid, a water-based liquid, or any suitable working fluid in any suitable combination.

With reference again to FIGS. 1, 2, 4 and 6-8, in one or more examples of the tool 100, the sealed vessel 102 also includes a lid 134. The lid 134 is configured to open the sealed vessel 102 to provide access to the first chamber 112 for positioning the first skin 202 and the core 204 inside the first chamber 112 and configured to close to seal the first chamber 112. After the lid 134 is open, prior to positioning the first skin 202 and the core 204, the first chamber 112 may be treated with a release agent to avoid sticking of the thermoplastic panel 200 during removal from the first chamber 112. Alternatively, prior to positioning the first skin 202 and the core 204, these items may be treated with a release agent for the same purpose. For example, the release agent may include a release film or a release liquid applied with a cloth or as a spray.

The lid 134 may include eyelets 140 or similar hardware to facilitate opening the lid 134 and/or lifting the lid 134 away from the tool 100. The tool 100 and/or lid 134 may include attaching hardware 142 suitable for securing the lid 134 in a closed position and for releasing the lid 134 to transition to an open position. The lid 134 may be configured such that, in the closed position, the height of the first chamber 112 is not less than the height of the thermoplastic panel 200 and about the same as the height of the thermoplastic panel 200 with a sufficient tolerance. For example, the lid 134 may be adjustable or sized such that the thermoplastic panel 200 is a close fit with a sufficient tolerance within the first chamber 112.

In another example of the tool 100, the heater 116 is disposed above the first chamber 112 within the lid 134. In a further example, the heater 116 is configured to selectively heat a bond line 216 between the first skin 202 and the core 204 of the thermoplastic panel 200 to a predetermined temperature associated with creating a fusion bond at the bond line 216 when the first skin 202 is proximate to the lid 134.

With reference again to FIGS. 1, 2, 4 and 6-8, in one or more examples of the tool 100, the lid 134 also includes an inlet fluid port 128′, an outlet fluid port 130′ and a heat exchanger 132′. The heat exchanger includes a plurality of cooling channels 502 in fluid communication with the inlet fluid port 128′ and the outlet fluid port 130′. The heat exchanger 132′ is disposed proximate to the heater 116 on an opposing side of the heater 116 in relation to the first chamber 112. The heat exchanger 132′ is configured to transfer heat from the bond line 216 of the thermoplastic panel 200 to a working fluid flowing through the plurality of cooling channels 502′ in response to receiving the working fluid via the inlet fluid port 128′.

In another example of the tool 100, the heat exchanger 132′ is configured to route the working fluid through the plurality of cooling channels 502′ and out the outlet fluid port 130′. In yet another example of the tool 100, the inlet fluid port 128′ is configured to interface with a supply line from a working fluid source and the outlet fluid port 130′ is configured to interface with a return line to the working fluid source.

In still another example of the tool 100, the working fluid is received by the heat exchanger 132′ in response to at least one of activating the working fluid source, opening the supply line, adjusting a flow rate for the working fluid, opening an inlet valve 136′ at the inlet fluid port 128′ and opening an outlet valve 138′ at the outlet fluid port 130′. The flow rate and temperature of the working fluid received by the heat exchanger 132′ may be adjusted to achieve desired temperatures at the bond line 216 at certain time intervals during a fusion bonding cycle.

In still yet another example of the tool 100, the working fluid includes a mineral-based oil, a synthetic-based oil, a coolant liquid, a water-based liquid, or any suitable working fluid in any suitable combination.

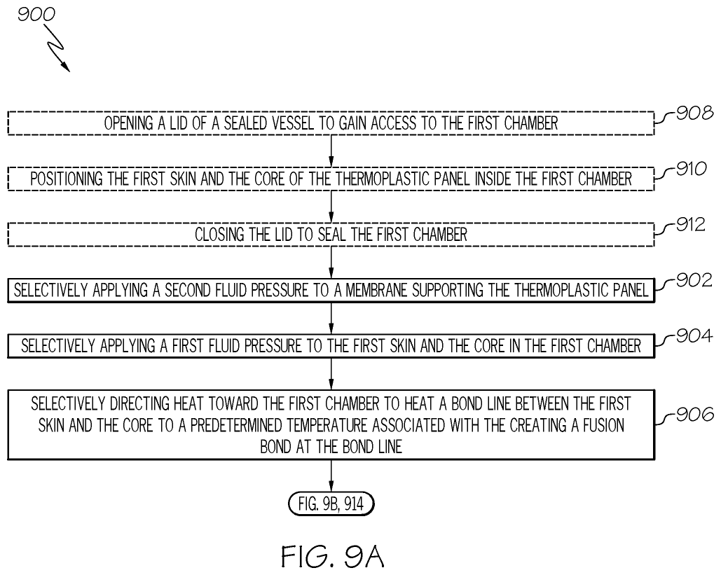

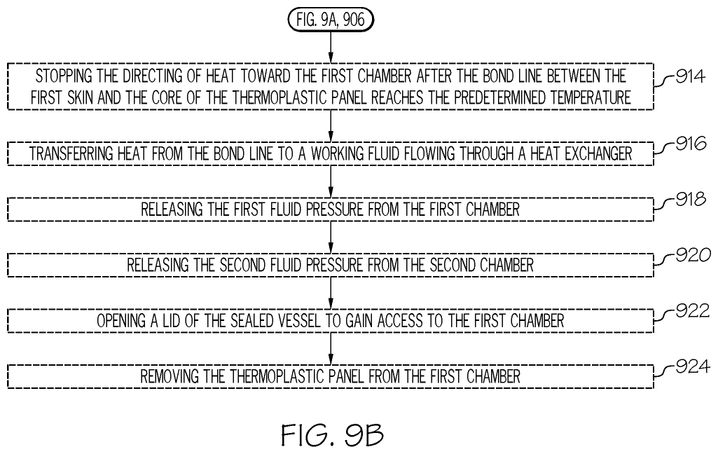

Referring generally to FIGS. 9A, 9B and 10-13, by way of examples, the present disclosure is directed to a method 900 for fabrication of a thermoplastic panel 200. Optional features in FIGS. 9A, 9B and 10-13 are depicted in dashed blocks of the flow diagrams.

With reference again to FIGS. 1, 2, 5, 7, 8, 9A and 9B, in one or more examples, a method 900 for fabricating a thermoplastic panel 200 begins at 902 where a second fluid pressure is applied to a membrane 110 supporting the thermoplastic panel 200. The thermoplastic panel 200 includes a first skin 202 and a core 204 previously positioned within a sealed vessel 102 divided into a first chamber 112 and a second chamber 114 by the membrane 110. The second fluid pressure being within the second chamber 114. At 904, a first fluid pressure is selectively applied to the first skin 202 and the core 204 in the first chamber 112. At 906, heat is selectively directed toward the first chamber 112 to heat a bond line 216 between the first skin 202 and the core 204 to a predetermined temperature associated with creating a fusion bond at the bond line 216.

In another example of the method 900, the first fluid pressure is based on a predetermined tool pressure of a first fluid supplied to the first chamber 112.

In a further example, the predetermined tool pressure for the first fluid ranges between about 2.5 bar (e.g., about 36 psi) and about 6.9 bar (e.g., about 100 psi) or any suitable tool pressure range. In other examples, the predetermined tool pressure for the first fluid may be about the same as the pressure of the second fluid.

In another further example, the first fluid includes a dry air, an inert gas, a nitrogen gas or any suitable fluid in any suitable combination. The first fluid is selected to facilitate heat transfer by convection in the first chamber 112 and to limit heat transfer by conduction.

In yet another further example, the method 900 also includes supplying the first fluid to the first chamber 112 in response to at least one of activating a first fluid source, opening a supply line to the first chamber 112, regulating a supply pressure for the first fluid to the predetermined tool pressure and opening a fluid port associated with the first chamber 112.

In yet another example of the method 900, the second fluid pressure is based on a predetermined tool pressure of a second fluid supplied to the second chamber 114.

In a further example, the predetermined tool pressure for the second fluid ranges between about 2.5 bar (e.g., about 36 psi) and about 6.9 bar (e.g., about 100 psi) or any suitable tool pressure range or any suitable tool pressure range. In other examples, the predetermined tool pressure for the second fluid may be about the same as the pressure of the first fluid.

In another further example, the second fluid includes a dry air, an inert gas, a nitrogen gas, a mineral-based oil, a synthetic-based oil or any suitable fluid in any suitable combination. The second fluid may be selected to facilitate heat transfer by conduction through the second chamber 114 toward the first chamber 112.

In yet another further example, the method 900 also includes supplying the second fluid to the second chamber 114 in response to at least one of activating a second fluid source, opening a supply line to the second chamber 114, regulating a supply pressure for the second fluid to the predetermined tool pressure and opening a fluid port associated with the second chamber 114.

In still another example of the method 900, the core 204 includes an air permeable thermoplastic foam, an air permeable thermoplastic honeycomb structure or any suitable core material in any suitable combination.

In still yet another example of the method 900, the thermoplastic panel 200 is a thermoplastic single skin panel 208.

In another example of the method 900, the thermoplastic panel 200 also includes an interlayer film 210 between the first skin 202 and the core 204 at the bond line 216 and the first fluid pressure is also selectively applied to the interlayer film 210.

In yet another example, prior to 902, the method 900 also includes opening 908 a lid 134 of a sealed vessel 102 to gain access to the first chamber 112. After the lid 134 is open, prior to positioning the first skin 202 and the core 204, the first chamber 112 may be treated with a release agent to avoid sticking of the thermoplastic panel 200 during removal from the first chamber 112. Alternatively, prior to positioning the first skin 202 and the core 204, these items may be treated with a release agent for the same purpose. For example, the release agent may include a release film or a release liquid applied with a cloth or as a spray. The lid 134 may include eyelets 140 or similar hardware to facilitate opening the lid 134 and/or lifting the lid 134 away from the tool 100.

At 910, the first skin 202 and the core 204 of the thermoplastic panel 200 are positioned inside the first chamber 112. At 912, the lid 134 is closed to seal the first chamber 112. The tool 100 and/or lid 134 may include attaching hardware 142 suitable for securing the lid 134 in a closed position and for releasing the lid 134 to transition to an open position. The lid 134 may be configured such that, in the closed position, the height of the first chamber 112 is not less than the height of the thermoplastic panel 200 and about the same as the height of the thermoplastic panel 200 with a sufficient tolerance. For example, the lid 134 may be adjustable or sized such that the thermoplastic panel 200 is a close fit with a sufficient tolerance within the first chamber 112. After 912, the method 900 advances to 902.

In still another example, after 906, the method 900 also includes stopping 914 the directing of heat toward the first chamber 112 after the bond line 216 between the first skin 202 and the core 204 of the thermoplastic panel 200 reaches the predetermined temperature. At 916, heat from the bond line 216 is transferred to a working fluid flowing through a heat exchanger 132.

Generally, the method 900 selectively directs heat 906 toward the first chamber 112 and stops 914 selectively directing the heat to establish a non-isothermal heating and cooling cycle to create the fusion bond between the first skin 202 and the core 204 of the thermoplastic panel 200.

In a further example, the method 900 also includes supplying the working fluid to the heat exchanger 132 in response to at least one of activating a working fluid source, opening a supply line to the heat exchanger 132, adjusting a flow rate for the working fluid, opening an inlet fluid port 128 associated with the heat exchanger 132 and opening an outlet fluid port 130 associated with the heat exchanger 132. The flow rate and temperature of the working fluid received by the heat exchanger 132 may be adjusted to achieve desired temperatures at the bond line 216 at certain time intervals during a fusion bonding cycle.

In another further example, the working fluid includes a mineral-based oil, a synthetic-based oil, a coolant liquid, a water-based liquid or any suitable working fluid in any suitable combination.

In yet another further example, after 916, the method 900 also includes releasing 918 the first fluid pressure from the first chamber 112. At 920, the second fluid pressure is released from the second chamber 114. At 922, a lid 134 of the sealed vessel 102 is opened to gain access to the first chamber 112. The lid 134 may include eyelets 140 or similar hardware to facilitate opening the lid 134 and/or lifting the lid 134 away from the tool 100. At 924, the thermoplastic panel 200 is removed from the first chamber 112.

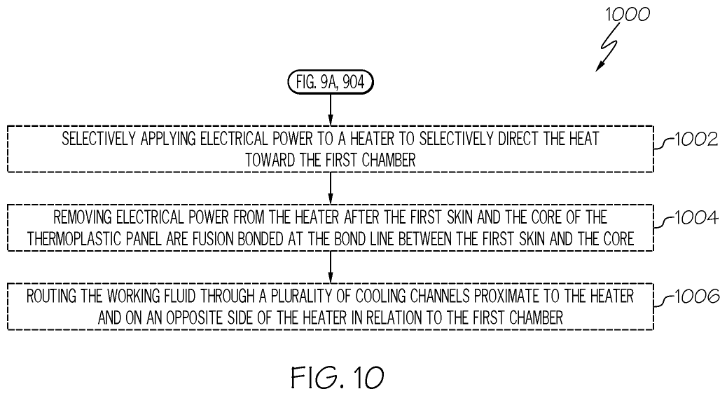

With reference again to FIGS. 1, 2, 4, 7, 8, 9A, 9B and 10, in one or more examples, a method 1000 (see FIG. 10) for fabrication of a thermoplastic panel includes the method 900 of FIGS. 9A and 9B. The method 1000 continues from 904 of FIG. 9A to 1002 where electrical power is selectively applied to a heater 116 to selectively direct the heat toward the first chamber 112. At 1004, electrical power is removed from the heater 116 after the first skin 202 and the core 204 of the thermoplastic panel 200 are fusion bonded at the bond line 216 between the first skin 202 and the core 204.

In another example of the method 900, the electrical power is removed from the heater 116 based at least in part on a predetermined heating time. In a further example, the predetermined heating time ranges between about 35 seconds and about 95 seconds, about 50 seconds and about 80 seconds, about 60 seconds and about 70 seconds, or any suitable heating time range.

In yet another example, the method 900 also includes routing 1006 the working fluid through a plurality of cooling channels 502 proximate to the heater 116 and on an opposite side of the heater 116 in relation to the first chamber 112.

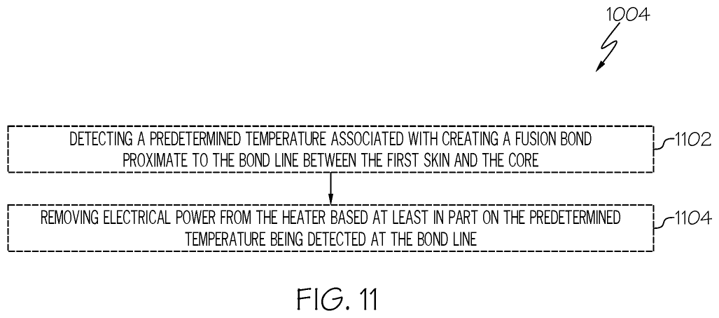

With reference again to FIGS. 1, 2, 4, 7, 8, 9A, 9B, 10 and 11, in one or more examples, item 1004 (see FIG. 10) of the method 1000 includes detecting 1102 (see FIG. 11) a predetermined temperature associated with creating a fusion bond proximate to the bond line 216 between the first skin 202 and the core 204. At 1104, electrical power is removed from the heater 116 based at least in part on the predetermined temperature being detected at the bond line 216. In another example of the method 900, the predetermined temperature ranges between about 240° C. and about 280° C., about 250° C. and about 270° C., about 255° C. and about 265° C., about 310° C. and about 350° C., about 335° C. and about 375° C., or any suitable temperature range.

With reference again to FIGS. 1, 2, 7, 8, 9A, 9B and 12, in one or more examples of the method 900, the thermoplastic panel 200 also includes a second skin 212, the first fluid pressure is also selectively applied to the second skin 212 and the heat is also selectively directed to heat a second bond line 216 between the second skin 212 and the core 204 to the predetermined temperature. In another example of the method 900, the thermoplastic panel 200 is a thermoplastic sandwich panel 214.

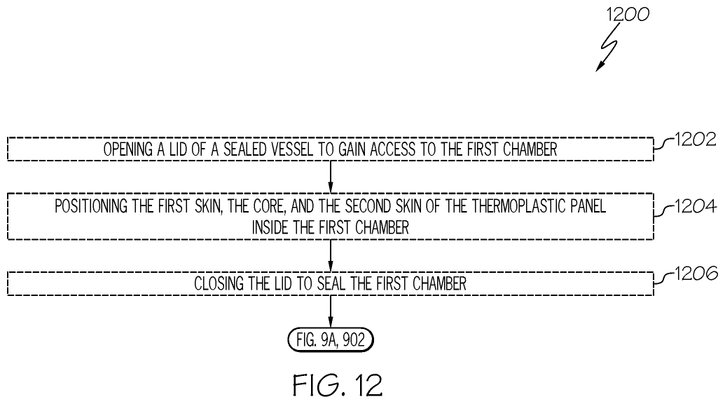

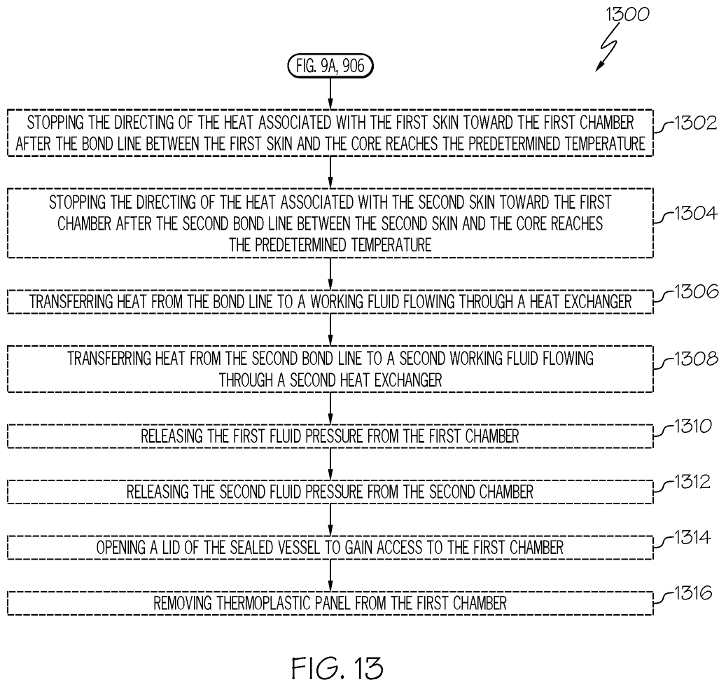

In another example, a method 1200 (see FIG. 12) for fabrication of a thermoplastic panel includes the method 900 of FIGS. 9A and 9B. The method 1200 begins at 1202 where a lid 134 of a scaled vessel 102 is opened to gain access to the first chamber 112. After the lid 134 is open, prior to positioning the first skin 202 and the core 204, the first chamber 112 may be treated with a release agent to avoid sticking of the thermoplastic panel 200 during removal from the first chamber 112. Alternatively, prior to positioning the first skin 202 and the core 204, these items may be treated with a release agent for the same purpose. For example, the release agent may include a release film or a release liquid applied with a cloth or as a spray. The lid 134 may include eyelets 140 or similar hardware to facilitate opening the lid 134 and/or lifting the lid 134 away from the tool 100.

At 1204, the first skin 202, the core 204 and the second skin 212 of the thermoplastic panel 200 are positioned inside the first chamber 112. At 1206, the lid 134 is closed to seal the first chamber 112. The tool 100 and/or lid 134 may include attaching hardware 142 suitable for securing the lid 134 in a closed position and for releasing the lid 134 to transition to an open position. The lid 134 may be configured such that, in the closed position, the height of the first chamber 112 is not less than the height of the thermoplastic panel 200 and about the same as the height of the thermoplastic panel 200 with a sufficient tolerance. For example, the lid 134 may be adjustable or sized such that the thermoplastic panel 200 is a close fit with a sufficient tolerance within the first chamber 112. After 1206, the method 900 advances to 902 of FIG. 9A.

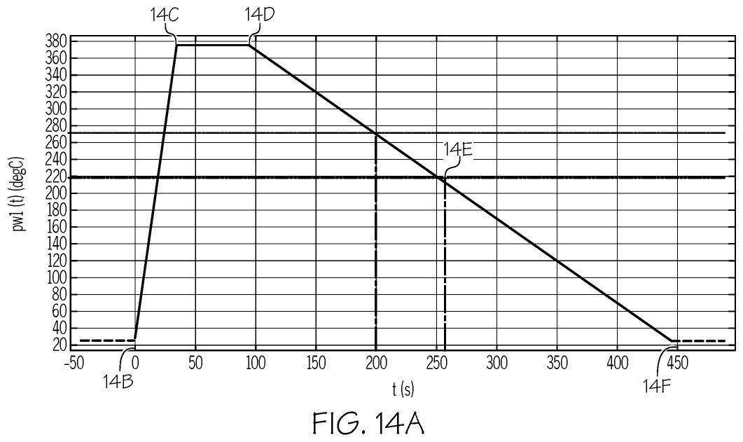

With reference again to FIGS. 1, 2, 5-8, 9A, 9B and 13, in one or more examples, a method 1300 (see FIG. 13) for fabrication of a thermoplastic panel includes the method 900 of FIGS. 9A and 9B. The method 1300 continues from 906 of FIG. 9A to 1302 where the directing of the heat associated with the first skin 202 toward the first chamber 112 is stopped after the bond line 216 between the first skin 202 and the core 204 of the thermoplastic panel 200 reaches the predetermined temperature. At 1304, the directing of the heat associated with the second skin 212 toward the first chamber 112 is stopped after the second bond line 216 between the second skin 212 and the core 204 of the thermoplastic panel 200 reaches the predetermined temperature. At 1306, heat is transferred from the bond line 216 to a working fluid flowing through a heat exchanger 132. At 1308, heat from the second bond line 216 is transferred to a second working fluid flowing through a second heat exchanger 132′.

In another example, the method 900 also includes releasing 1310 the first fluid pressure from the first chamber 112. At 1312, the second fluid pressure is released from the second chamber 114. At 1314, a lid 134 of the sealed vessel 102 is opened to gain access to the first chamber 112. The lid 134 may include eyelets 140 or similar hardware to facilitate opening the lid 134 and/or lifting the lid 134 away from the tool 100. At 1316, the thermoplastic panel 200 is removed from the first chamber 112.

With reference again to FIGS. 2 and 3, in one or more examples, a thermoplastic panel 200 includes a first skin 202 and a core 204 bonded to the first skin 202. The core 204 includes a honeycomb structure 300 with an array of hollow cells 302 that are orthogonal to the first skin 202. The array of hollow cells 302 are formed by cell walls 304. The cell walls 304 have a plurality of breather holes 306 such that the honeycomb structure 300 is air permeable from cell to cell.

In another example, the thermoplastic panel 200 is a thermoplastic single skin panel 208.

In yet another example, the thermoplastic panel 200 also includes a second skin 212. In a further example, the thermoplastic panel 200 is a thermoplastic sandwich panel 214.

In still another example of the thermoplastic panel 200, the array of hollow cells 302 includes octagonal-shaped cells, hexagonal-shaped cells, rectangular-shaped cells, square-shaped cells, tubular-shaped cells, corrugated-shaped cells, triangular-shaped cells or cells of any suitable shape in any suitable combination.

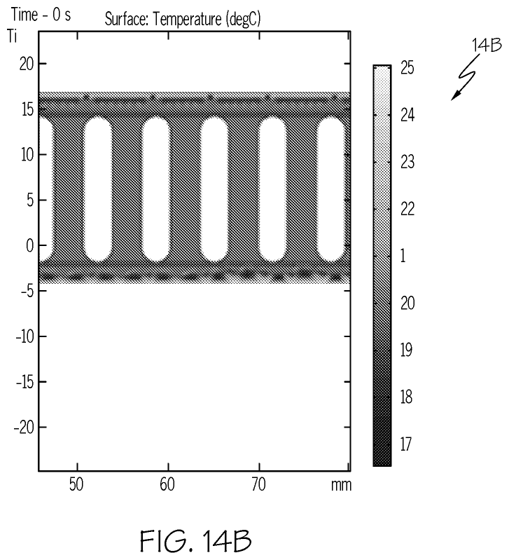

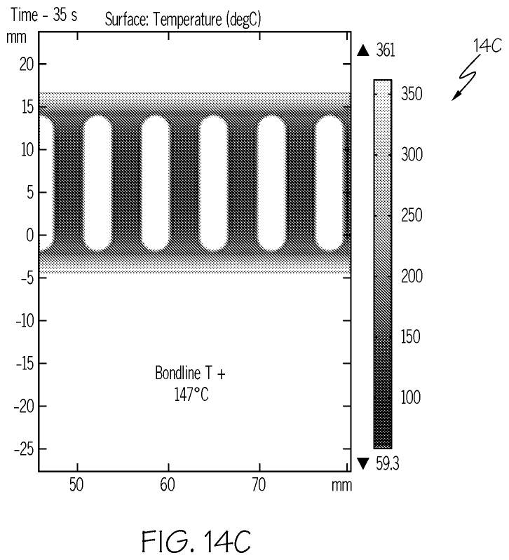

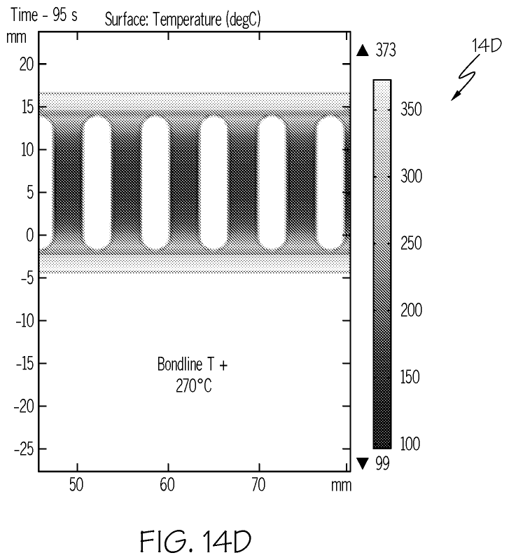

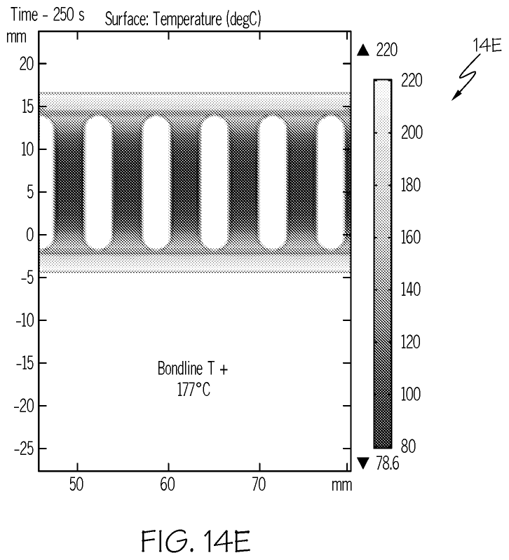

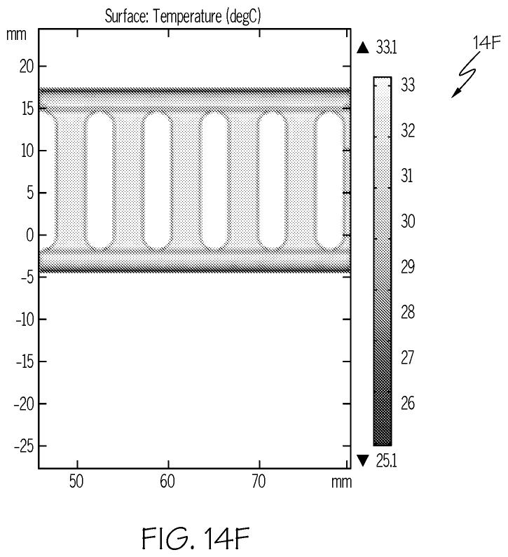

Referring generally to FIGS. 14A-14F, this group of drawings provides a graph (see FIG. 14A) and five images of a thermoplastic sandwich panel associated with a trial fabrication using an example of the tool 100 disclosed here. The graph and the five images show a heating and cooling cycle during the trial fabrication.

Examples of tools 100 for fabrication of thermoplastic panels, methods 900, 1000, 1200, 1300 and thermoplastic panels 200 may be related to, or used in the context of aircraft manufacturing. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may apply to the use of thermoplastic panels for manufacturing various types of vehicles and for construction of residential and commercial buildings.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1, 2, 3A, 3B and 4-8, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1, 2, 3A, 3B and 4-8, referred to above, need be included in every example and not all elements, features, and/or components described herein are necessarily depicted in each illustrative example. Accordingly, some of the elements, features, and/or components described and illustrated in FIGS. 1, 2, 3A, 3B and 4-8 may be combined in various ways without the need to include other features described and illustrated in FIGS. 1, 2, 3A, 3B and 4-8, other drawing figures, and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 1, 2, 3A, 3B and 4-8, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1, 2, 3A, 3B and 4-8, and such elements, features, and/or components may not be discussed in detail herein with reference to each of FIGS. 1, 2, 3A, 3B and 4-8. Similarly, all elements, features, and/or components may not be labeled in each of FIGS. 1, 2, 3A, 3B and 4-8, but reference numerals associated therewith may be utilized herein for consistency.

In FIGS. 9A, 9B and 10-13, referred to above, the blocks may represent operations, steps, and/or portions thereof, and lines connecting the various blocks do not imply any particular order or dependency of the operations or portions thereof. It will be understood that not all dependencies among the various disclosed operations are necessarily represented. FIGS. 9A, 9B and 10-13 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

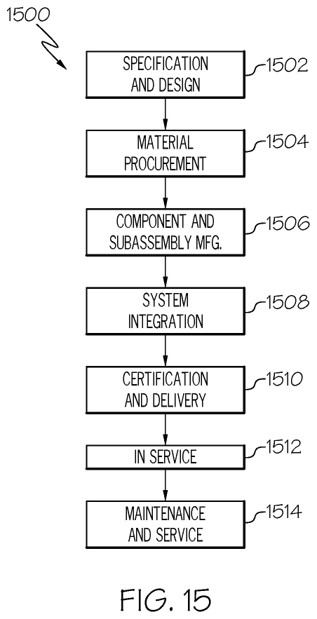

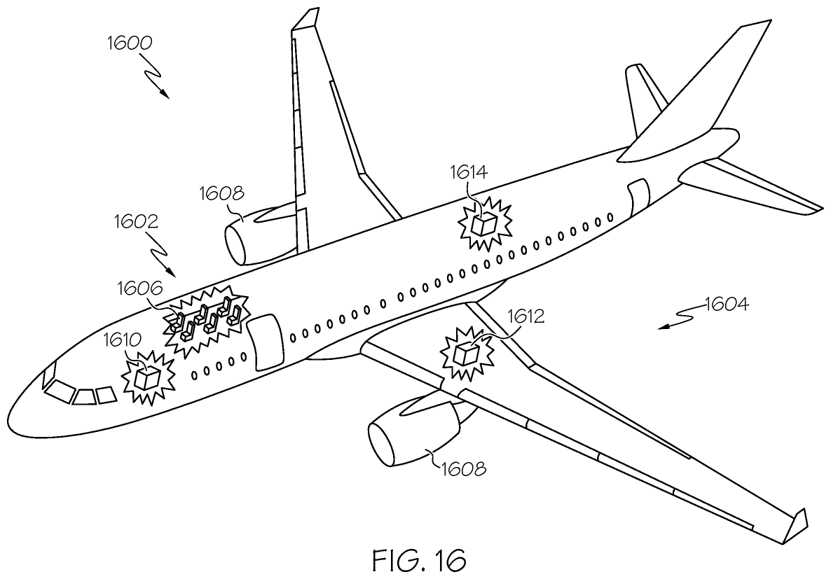

Examples of the subject matter disclosed herein may be described in the context of aircraft manufacturing and service method 1500 as shown in FIG. 15 and aircraft 1600 as shown in FIG. 16. In one or more examples, the disclosed methods and systems for associating test data for a part under test with an end item coordinate system may be used in aircraft manufacturing. During pre-production, the service method 1500 may include specification and design (block 1502) of aircraft 1600 and material procurement (block 1504). During production, component and subassembly manufacturing (block 1506) and system integration (block 1508) of aircraft 1600 may take place. Thereafter, aircraft 1600 may go through certification and delivery (block 1510) to be placed in service (block 1512). While in service, aircraft 1600 may be scheduled for routine maintenance and service (block 1514). Routine maintenance and service may include modification, reconfiguration, refurbishment, etc. of one or more systems of aircraft 1600.

Each of the processes of the service method 1500 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 16, aircraft 1600 produced by the service method 1500 may include airframe 1602 with a plurality of high-level systems 1604 and interior 1606. Examples of high-level systems 1604 include one or more of propulsion system 1608, electrical system 1610, hydraulic system 1612, and environmental system 1614. Any number of other systems may be included. Although an aerospace example is shown, the principles disclosed herein may be applied to other industries, such as the automotive industry. Accordingly, in addition to aircraft 1600, the principles disclosed herein may apply to other vehicles, e.g., land vehicles, marine vehicles, space vehicles, etc.

The disclosed systems and methods for associating test data for a part under test with an end item coordinate system may be employed during any one or more of the stages of the manufacturing and service method 1500. For example, components or subassemblies corresponding to component and subassembly manufacturing (block 806) may be fabricated or manufactured in a manner similar to components or subassemblies produced while aircraft 1600 is in service (block 1512). Also, one or more examples of the system(s), method(s), or combination thereof may be utilized during production stages (block 1506 and block 1508), for example, by substantially expediting assembly of or reducing the cost of aircraft 1600. Similarly, one or more examples of the system or method realizations, or a combination thereof, may be utilized, for example and without limitation, while aircraft 1600 is in service (block 1512) and/or during maintenance and service (block 1514).

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the tool 100 for fabrication of a thermoplastic panel, associated methods 900, 1000, 1200, 1300 and thermoplastic panel 200 have been shown and described, modifications may occur to those skilled in the art upon reading the specification. The present application includes such modifications and is limited only by the scope of the claims.

1. A tool for fabrication of a thermoplastic panel, comprising:
a sealed vessel defining a volume, the sealed vessel comprising a first fluid port and a second fluid port;
a membrane disposed within the volume to define a first chamber and a second chamber, the first chamber configured to receive a first skin and a core of the thermoplastic panel and configured to selectively apply a first fluidic pressure to the first skin and the core in response to receiving a first fluid via the first fluid port, the membrane configured to abut a major surface of the thermoplastic panel and the second chamber configured to selectively apply a second fluidic pressure to the membrane in response to receiving a second fluid via the second fluid port; and
a heater configured to selectively direct heat toward the first chamber.

2-11. (canceled)

12. The tool of claim 1, wherein the membrane comprises a metal alloy.

13-17. (canceled)

18. The tool of claim 1, wherein the core comprises at least one of an air permeable thermoplastic foam and an air permeable thermoplastic honeycomb structure.

19. The tool of claim 18, wherein the air permeable thermoplastic honeycomb structure comprises an array of hollow cells orthogonal to the first skin, the array of hollow cells formed by cell walls, the cell walls having a plurality of breather holes such that the air permeable thermoplastic honeycomb structure is air permeable from cell to cell.

20-28. (canceled)

29. The tool of claim 1, wherein the first fluid comprises at least one of a dry air, an inert gas and a nitrogen gas.

30-31. (canceled)

32. The tool of claim 1, wherein the second fluid comprises at least one of a dry air, an inert gas, a nitrogen gas, a mineral-based oil and a synthetic-based oil.

33-34. (canceled)

35. The tool of claim 1, wherein the heater is disposed below the second chamber.

36-37. (canceled)

38. The tool of claim 36, the tool further comprising:
a heating controller in operative communication with the heater to selectively apply electrical power to the plurality of electric cartridge heaters after the second fluid is received by the second chamber and after the first fluid is received by the first chamber, and
wherein the heating controller is configured to remove electrical power from the plurality of electric cartridge heaters after the first skin and the core of the thermoplastic panel are fusion bonded at a bond line between the first skin and the core.

39. The tool of claim 38, wherein the heating controller is configured to remove electrical power from the plurality of electric cartridge heaters based at least in part on a predetermined heating time.

40. The tool of claim 39, wherein the predetermined heating time ranges between at least one of about 35 seconds and about 95 seconds, about 50 seconds and about 80 seconds and about 60 seconds and about 70 seconds.

41. The tool of claim 38, the sealed vessel further comprising:
at least one temperature sensor within the first chamber and proximate to the bond line between the first skin and the core,
wherein the heating controller is in operative communication with the at least one temperature sensor and configured to remove electrical power from the plurality of electric cartridge heaters based at least in part on a temperature signal from the at least one temperature sensor indicating a predetermined temperature associated with creating a fusion bond is detected proximate to the bond line.

42. The tool of claim 41, wherein the predetermined temperature ranges between at least one of about 240° C. and about 280° C., about 250° C. and about 270° C., about 255° C. and about 265° C., about 310° C. and about 350° C. and about 335° C. and about 375° C.

43. The tool of claim 1, wherein the heater is configured to selectively heat a bond line between the first skin and the core of the thermoplastic panel to a predetermined temperature associated with creating a fusion bond at the bond line.

44. (canceled)

45. The tool of claim 43, wherein the sealed vessel further comprises:
an inlet fluid port; and
an outlet fluid port, and
wherein the tool further comprises:
a heat exchanger comprising a plurality of cooling channels in fluid communication with the inlet fluid port and the outlet fluid port, the heat exchanger disposed proximate to the heater on an opposing side of the heater in relation to the first chamber, the heat exchanger configured to transfer heat from the bond line of the thermoplastic panel to a working fluid flowing through the plurality of cooling channels in response to receiving the working fluid via the inlet fluid port.

46. The tool of claim 45, wherein the heat exchanger is configured to route the working fluid through the plurality of cooling channels and out the outlet fluid port.

47-49. (canceled)

50. The tool of claim 1, the sealed vessel further comprising:
a lid configured to open the sealed vessel to provide access to the first chamber for positioning the first skin and the core inside the first chamber and configured to close to seal the first chamber.

51. The tool of claim 50, wherein the heater is disposed above the first chamber within the lid.

52. The tool of claim 51, wherein the heater is configured to selectively heat a bond line between the first skin and the core of the thermoplastic panel to a predetermined temperature associated with creating a fusion bond at the bond line when the first skin is proximate to the lid.

53-57. (canceled)

58. A method for fabrication of a thermoplastic panel, comprising:
selectively applying a second fluid pressure to a membrane supporting the thermoplastic panel, wherein the thermoplastic panel comprises a first skin and a core previously positioned within a sealed vessel divided into a first chamber and a second chamber by the membrane, the second fluid pressure being within the second chamber;
selectively applying a first fluid pressure to the first skin and the core in the first chamber; and
selectively directing heat toward the first chamber to heat a bond line between the first skin and the core to a predetermined temperature associated with creating a fusion bond at the bond line.

59-85. (canceled)

86. A thermoplastic panel, comprising:
a first skin; and
a core bonded to the first skin and comprising a honeycomb structure with an array of hollow cells that are orthogonal to the first skin, the array of hollow cells formed by cell walls, the cell walls having a plurality of breather holes such that the honeycomb structure is air permeable from cell to cell.

87-90. (canceled)
